(19) United States
(12) Patent Application Publication
(10) Pub. No.: US 2012/0102480 A1
(43) Pub. Date: Apr. 26, 2012

(54) HIGH AVAILABILITY OF MACHINES DURING PATCHING

(75) Inventors: Alexander Hopmann, Seattle, WA (US); Zach Rosenfield, Seattle, WA (US); Marc Keith Windle, Woodinville, WA (US); Patrick Simek, Redmond, WA (US); Erick Raymundo Lerma, Bothell, WA (US); Doron Bar-Caspi, Redmond, WA (US); Tarkan Sevilmis, Redmond, WA (US); Maxim Lukiyanov, Redmond, WA (US)

(73) Assignee: MICROSOFT CORPORATION, Redmond, WA (US)

(21) Appl. No.: 12/908,623

(22) Filed: Oct. 20, 2010

(51) Int. Cl. G06F 9/44

(52) U.S. Cl. 717/172

(57) ABSTRACT

A cloud manager is utilized in the patching of physical machines and virtual machines that are used within an online service, such as an online content management service. The cloud manager assists in the scheduling of the application of software patches to the machines (physical and virtual) within the network such that the availability of the online service is maintained while machines are being patched. The machines to be patched are partitioned into groups that are patched at different times. Generally, the groups are partitioned into a highly available independent groups of machines such that one or more of the groups that are not currently being patched continue to provide the service(s) of the group that is being patched. The machines (physical and virtual) within each of the groups may be patched in parallel.

### BACKGROUND

Web-based applications include files that are located on web servers along with data that is stored in databases. For example, there are a large number of servers located within different networks to handle the traffic that is directed to the service. Managing the deployment, upgrades, patching and operations of the online service that includes a large number of servers is a time consuming process that requires a large operations staff that is subject to human error.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A cloud manager is utilized in the patching of physical machines and virtual machines that are used within an online service. The cloud manager assists in the scheduling of the application of software patches to the machines (physical and virtual) within the network such that the availability of the online service is maintained while machines are being patched. The machines to be patched are partitioned into groups that are patched at different times. Generally, the groups are partitioned into a highly available independent groups of machines such that one or more of the groups that are not currently being patched continue to provide the service(s) of the group that is being patched. The machines (physical and virtual) within each of the groups may be patched in parallel.

### BRIEF DESCRIPTION OF THE DRAWINGS

FIG. 1 illustrates a cloud manager system for managing networks that are associated with an online service, such as a content management service;

FIG. 2 shows a cloud manager including managers and associated databases;

FIG. 3 shows an exemplary job record stored within a row of a database;

FIG. 4 shows an example system for a network including front-end and back-end servers for an online service;

FIG. 5 illustrates a computer architecture for a computer;

FIG. 6 shows a patch system for patching machines that are used within an online service; and

FIG. 7 shows a process for patching machines in an online system.

### DETAILED DESCRIPTION

Referring now to the drawings, in which like numerals represent like elements, various embodiment will be described.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

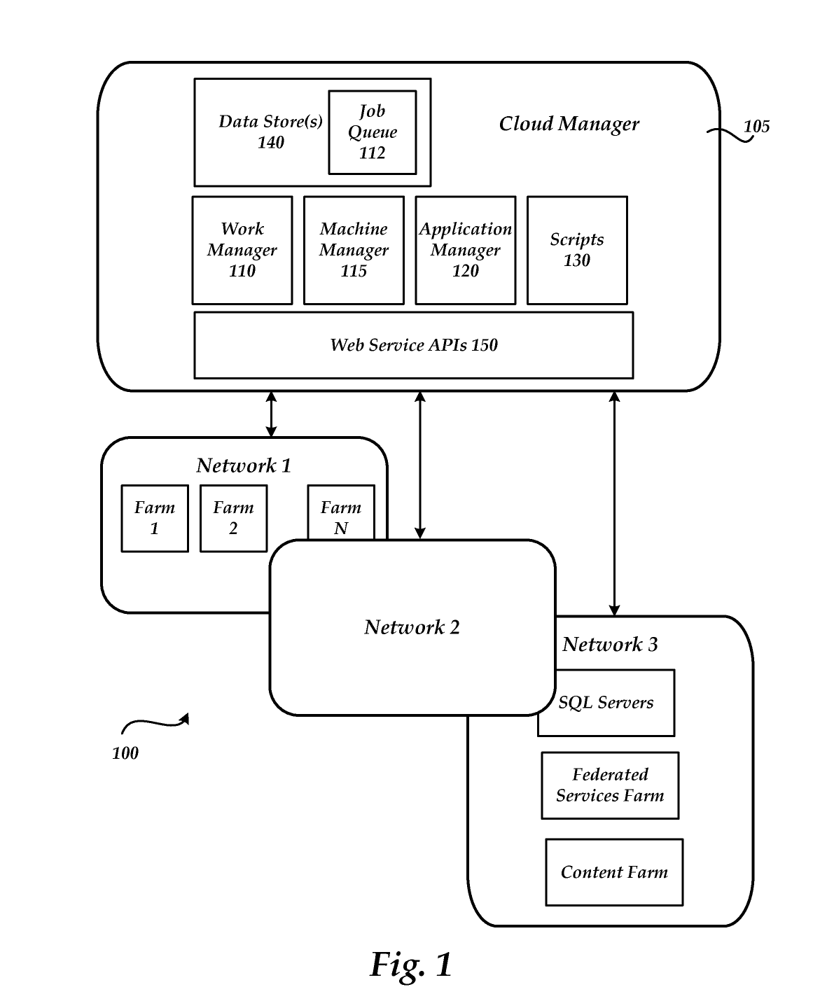

FIG. 1 illustrates a cloud management system for managing networks that are associated with an online service. System 100 illustrates cloud manager 105 that is connected to and manages different networks potentially distributed across the world. Each of the networks is configured to provide content services for one or more tenants (e.g. clients, customers). The networks may be hosted within a cloud service and/or in an on-premises data center. Cloud manager 105 is used in deploying, configuring and managing the networks. The cloud manager is configured to receive requests through an idempotent and asynchronous application web service application programming interface (API) 150 that can tolerate intermittent network failures.

As illustrated, cloud manager 105 comprises work manager 110, machine manager 115, application specific manager 120, scripts 130 and a central repository, such as data store(s) 140 (e.g. databases). The functionality that is not included within one of the illustrated managers may reside in some other location of the cloud manager. According to one embodiment, application manager 120 is a SharePoint tenant manager that comprises SharePoint specific logic.

Work manager 110 manages the execution of tasks and enables scheduling and retry of longer running tasks. Work manager 110 starts jobs stored in job queue 112 and keeps track of running jobs. When a predetermined time has elapsed, work manager 110 may automatically cancel the task and perform some further processing relating to the task. According to one embodiment, the tasks in job queue 112 are executed by work manager 110 by invoking one or more scripts 130. For example, a scripting language such as Microsoft's PowerShell® may be used to program the tasks that are executed by work manager 110. Each script may be run as a new process. While executing each script as a new process may have a fairly high CPU overhead, this system is scalable and helps to ensure a clean environment for each script execution plus full cleanup when the script is completed.

Machine manager 115 is configured to manage the physical machines in the networks (e.g. Network 1, Network 2, Network 3). Generally, machine manager 115 understands Networks, Physical Machines, Virtual Machines (VMs), VM Images (VHDs), and the like. The machine manager does not have a strong binding to the specific services running within the networks but keeps track of the various components in the networks in terms of “roles.” For example machine manager 115 could be requested through API 150 to deploy a VM of type “Foo” with version 12.34.56.78 on Network 3. In response to a request to cloud manager 105, machine manager 115 locates a suitable Physical Machine that is located on Network 3 and configures the VM according to the VM Image associated with the VM's Role. The physical machine is configured with a VHD of type Foo with version 12.34.56.78 that is stored within a data store, such as data store 140. The images used within the network may also be stored in other locations, such as a local data share for one or more of the networks. Scripts may be run to perform the installation of the VHD on the physical machine as well as for performing any post-deployment configuration. Machine manager 115 keeps track of the configuration of the machines each network. For example, machine manager 115 may keep track of a VM's role (type of VM), state of the VM (Provisioning, Running, Stopped, Failed), version and whether the VM exists in a given farm (which implies their network).

Scripts 130 is configured to store scripts that are executed to perform work both locally for cloud manager 105 and remotely on one or more of the networks. One or more of the scripts 130 may also be stored in other locations. For example, scripts to be performed on a network (e.g. Network 1, Network 2, Network 3) may be stored locally to that network. The scripts may be used for many different purposes. For example, the scripts may be used to perform configurations of machines in one or more of the networks, changing settings on previously configured machines, add a new VM, add a new database, move data from one machine to another, move tenants, change schemas, and the like. According to one embodiment, the scripts are Microsoft's PowerShell® scripts. Other programming implementations may be used. For example, a compiled and/or early-bound programming language may be used to implement the functionality. Scripting, however, is a fairly concise language to express many of the tasks that are to be performed. Programming the equivalent in a programming language, such as C#, would often require much more verbose implementations. The scripts are also late-bound, meaning that multiple versions of underlying code-bases can be targeted without having to constantly link to different interface DLLs. Using PowerShell scripts allows a process to be started locally by cloud manager 105 that may in turn start a process on a remote machine (i.e. a physical machine in one of the attached networks). Other techniques may also be used to start a process on a remote machine, such as Secure Shell (SSH) and the like.

Application specific information that cloud manager 105 is managing is performed by application manager 120. According to one embodiment, the application specific information relates to Microsoft SharePoint®. As such, application manager 120 is configured to know about SharePoint Tenants, Site Collections, and the like.

Each network may be configured as a dedicated network for a tenant and/or as a multi-tenant network that services more than one client. The networks may include a changing number of physical/virtual machines with their configuration also changing after deployment. Generally, a network may continue to grow as long as the networking limits (e.g. load balancer and network switches) are not exceeded. For example, a network may start out with ten servers and later expand to one hundred or more servers. The physical machines within a network may be assigned a class or type. For example, some of the machines may be compute machines (used for web front ends and app servers) and other machines may be storage machines that are provisioned with more storage than compute machines. According to an embodiment, cloud manager 105 configures the machines within a network with multiple versions of the image files. According to an embodiment, farms usually have a same version of image files.

According to one embodiment, the software limits are managed by the cloud manager system 100 within the network by virtualizing the machines and managing independently acting “Farms” inside the network. Each network may include one or more farms (e.g. see Network 1). According to one embodiment, a network is considered a single cluster of network load balanced machines that expose one or more VIP (Virtual IP) to the outside world and can route that traffic to any of the machines within the network. The machines in the network generally are tightly coupled and have minimum latencies (i.e. <1 ms ping latency).

Farms are the basic grouping of machines used to coordinate applications that need tightly bound relationships. For example, content farms may be deployed within each of the networks for a content management application, such as Microsoft SharePoint®. Generally, the set of machines in each of the farms provide web service and application server functions together. Typically, the machines inside the farm are running the same build of an application (i.e. SharePoint) and are sharing a common configuration database to serve specific tenants and site collections.

Farms can contain heterogeneous sets of virtual machines. Cloud manager 105 maintains a “farm goal” within data store 140 which is a target number of machines of each role for each farm. Some roles include Content Front End, Content Central Admin, Content Timer Service, Federated Central Admin, Federated App Server etc. For example, content farms are the basic SharePoint farm that handles incoming customer requests. Federated Services farms contain SharePoint services that can operate cross farms such as search and the profile store. Farms may be used for hosting large capacity public internet sites. Some farms may contain a group of Active Directory servers and a Provisioning Daemon. Cloud manager 105 automatically deploys and/or decommissions virtual machines in the networks to help in meeting the defined target. These farms goals may be automatically and/or manually configured. For example, the farm goals may change to respond to changes in activity and capacity needs. Network Farm—there is one network farm per Network that contains all the VM roles that scale out easily as a resource to the whole Network.

The Cloud Manager Web Service APIs 150 are designed to work in the context of a massively scalable global service. The APIs assume that any network request might fail and/or hang in transit. Calls to cloud manager 105 are configured to be idempotent. In other words, the same call may be made to cloud manager 105 multiple times (as long as the parameters are identical) without changing the outcome.

Cloud manager 105 is designed to do very little processing (<10 ms, <50 ms) before returning a response to any given request. Cloud manager 105 maintains records to keep track of current requests. For example, cloud manager 105 updates records in a local database and if necessary schedules a “job” to perform more lengthy activity later.

Cloud manager keeps track of Images (such as Virtual Disk Images) that are the templates used to deploy new machines within a network. The Image references may be stored in a database, such as database 140, and/or in some other location. The images may be stored in one or more shared data stores that are local to the network(s) on which the image will be deployed. According to one embodiment, each Image includes a virtual machine (VM) role type that specifies the type of VM it can deploy, the number of processors that it should use, the amount of RAM that it will be assigned, a network ID used to find a nearby install point (so they don't get copied repeatedly over the cross data-center links) and a share path that the deployment code can use to access the VHD.

Generally, machines in the networks being managed by cloud system 100 are not upgraded in the traditional manner by downloading data and incorporating the data into the existing software on the machine. Instead, machines are updated by replacing a VHD with an updated VHD. For example, when a new version of software is needed by a farm, a new farm is deployed that has the new version installed. When the new farm is deployed, the tenants are moved from the old farm to the new farm. In this way, downtime due to an upgrade is minimized and each machine in the farm has a same version that have been tested. When a virtual machine needs to be upgraded, the VM on the machine may be deleted and replaced with the VM that is configured to run the desired service.

While upgrades to existing software are not optimal, some servers within the networks do utilize the traditional update procedure of an in-place upgrade. For example, Active Directory Domain Controllers are upgraded by updating the current software on the server without completely replacing an image on the machine. The cloud manager may also be upgraded in place in some instances.

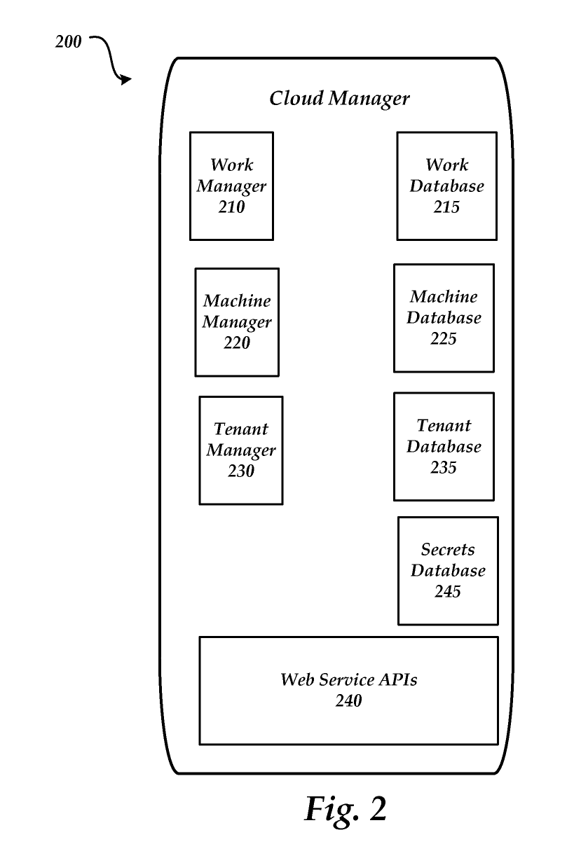

FIG. 2 shows a cloud manager including managers and associated databases. As illustrated, cloud manager 200 comprises work manager 210, work database 215, machine manager 220, machine database 225, tenant manager 230, tenant database 235, secrets database 245 and web service APIs 240.

Generally, databases used within a cloud management system (e.g. system 100) are sized to enable high performance. For example, a database (such as work database 215, machine database 225, tenant database 235 and secrets database 245) may not exceed a predefined size limit (e.g. 30 GB, 50 GB, 100 GB, and the like). According to an embodiment, a database is sized such that it is small enough to fit in-memory of a physical machine. This assists in high read I/O performance. The size of the database may also be selected based on performance with an application program, such as interactions with a SQL server. The databases used in the farms may also be sized to enable high performance. For example, they may be sized to fit in-memory of the host machine and/or sized such that backup operations, move operations, copy operations, restore operations are generally performed within a predetermined period of time.

Cloud manager 200 divides the cloud manager data into four databases. The work database 215 for the work manager. The machine database 225 for the machine manager 220. The tenant database 235 for the tenant manager 230 and a secrets database 245 for storing sensitive information such as system account and password information, credentials, certificates, and the like. The databases may be on the same server and or split across servers. According to an embodiment, each database is mirrored for high availability and is a SQL database.

Cloud manager 200 is configured to interact with the databases using a reduced set of SQL features in order to assist in providing availability of the cloud manager 200 during upgrades of the databases. For example, foreign keys or stored procedures are attempted to be avoided. Foreign keys can make schema changes difficult and cause unanticipated failure conditions. Stored procedures place more of the application in the database itself.

Communications with the SQL servers are attempted to be minimized since roundtrips can be expensive compared to the cost of the underlying operation. For example, its usually much more efficient if all of the current SQL server interactions to a single database are wrapped in a single round-trip.

Constraints are rarely used within the databases (215, 225, 235). Generally, constraints are useful when it helps provide simple updates with the right kind of error handing without extra queries. For example, the fully qualified domain name (FQDN) table has a constraint placed on the “name” to assist in preventing a tenant from accidentally trying to claim the same FQDN as is already allocated to a different tenant.

Caution is used when adding indices. Indices typically improve read performance at the cost of extra I/Os for write operations. Since the data within the databases is primarily RAM resident, even full table scans are relatively fast. According to an embodiment, indices may be added once the query patterns have stabilized and a performance improvement may be determined by proposed indices. According to an embodiment, if adding the index will potentially take a long time the “ONLINE=ON” option may be specified such that the table isn't locked while the index is initially built.

According to an embodiment, upgrades to databases within the cloud manager may be performed without causing downtime to the cloud manager system. In other words, even during an upgrade of the cloud manager, the cloud manager continues processing received requests. As such, changes made to the schema are to be compatible with the previous schema. The SQL schema upgrade is run before the web servers used by the cloud manager are upgraded. When the web servers are upgraded they can start to use the new features enabled in the database. Database upgrades are limited such that operations involved in the upgrade are quick and efficient. For example, tables may be added and new nullable columns may be added to existing columns. New columns may be added at the end of a table. Generally, time consuming operations to the databases are avoided. For example, adding a default value to a newly added column at creation time may be a very time consuming operation when there is a large amount of data. Adding a nullable column, however, is a very quick operation. As discussed above, adding new indices are allowed, but caution should be taken when adding a new constraint to help ensure sure that the schema upgrade won't break with the existing data. For example, when a constraint is added it may be set to a state that is not checked and avoids a costly validation of existing rows and potential errors. Old tables and unused columns are removed after a new version is being used and the cloud manager is not accessing those tables and columns.

Generally, a single row in each of the databases is used to indicate a task and/or a desired state. For example, the tenant database 235 includes a single row for each tenant. A given tenant may include a Required Version record. This record is used to help ensure that the tenant is placed on a farm running the required version. For example, for tenant 1 to stay on SharePoint 14 SP1, the required version for tenant could be set to “14.1.” and any version including 14.1 would match and any other versions (e.g. 14.2.xxxx) would not match. The tenant records may include other items such as authorized number of users, quotas (e.g. allowed total data usage, per user data usage, etc.), time restrictions, and the like. Some organization might have multiple tenants that represent different geographies, organizations or capabilities. According to an embodiment, tenants are walled off from each other without explicit invitation of the users (via extranet or other features).

According to one embodiment, each tenant is locked into a specific network. Tenants are kept localized to a small set of databases. A tenant is either small (smaller than would fill one database) in which case it is in exactly one database, shared with other tenants. This implies that all the tenants sharing that database need to upgrade at the same time. When a tenant grows larger it may be moved to its own dedicated database(s) and now might have more than one, but is not sharing databases with other tenants. Maintaining a large tenant in one or more dedicated databases helps in reducing a number of databases that are needed to be upgraded simultaneously in a single upgrade.

Similarly, the work database 215 includes a single row for each job. The machine database 225 may include a row for each physical machine, VM, farm, and the like. For example, machine manager database 225 may include a version string. According to an embodiment, each VHD, Farm, and VM within a network has an associated version string.

According to one embodiment, the cloud manager includes a simple logging system that may be configured to record a log entry for each web service call. A logging system may be implemented that includes as few/many features as desired. Generally, the logging system is used for measuring usage and performance profiling.

According to an embodiment, the Web Service APIs 240 are built using SOAP with ASP.net. The various Web Methods in the APIs follow two main patterns—Gets and Updates. Generally, the update methods take a data structure as the input and return the same structure as the output. The output structure returns the current state of the underlying object in the database, potentially differing from the input object if validation or other business logic changed some properties or else with additional properties filled in (for example record IDs or other values calculated by the cloud manager). The update methods are used for initial object creation as well as subsequent updates. In other words, callers to the web service APIs 240 can simply request the configuration they want and they don't need to keep track of whether the object already exists or not. In addition this means that updates are idempotent in that the same update call can be made twice with the identical effect to making it only once. According to an embodiment, an update method may include a LastUpdated property. When the LastUpdated property is present, the cloud manager 200 rejects the Update if the value of LastUpdate does not match the one currently stored in the database. Some Update methods include properties that are set on the first invocation of the method and are not set on other invocations of the method.

Cloud manager 200 is configured to avoid the use of callbacks. Since callbacks may be unreliable, clients interacting with cloud manager 200 may check object status using a web service API when they want to check a status of an update. According to an embodiment, a call to an update method causes cloud manager 200 to set the state of the underlying object to “Provisioning” and when the updates are completed the state is set to “Active”.

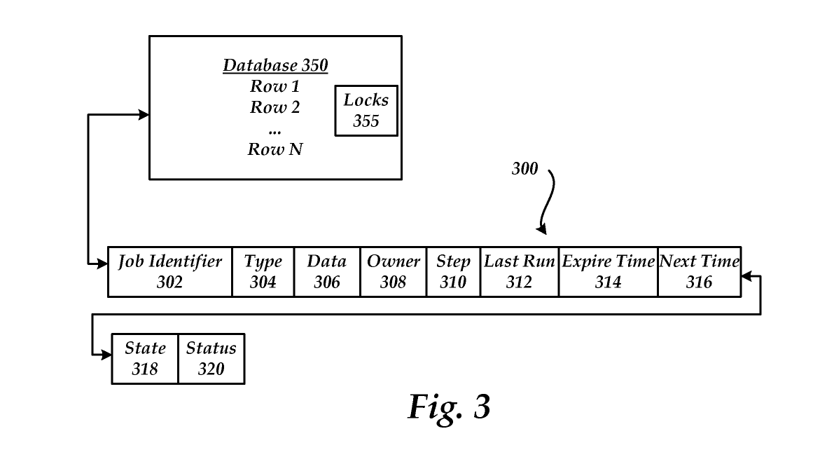

FIG. 3 shows an exemplary job record stored within a row of a database. As illustrated, record 300 comprises job identifier 302, type 304, data 306, owner 308, step 310, last run 312, expire time 314, next time 316, state 318 and status 320.

Generally, for each task that is requested to be performed, the cloud manager creates a record in database 350 (e.g. work database 215 in FIG. 2).

Job identifier 302 is used to specify a unique identifier for the requested task.

Type 304 specifies the task to perform. For example, the type may include a name of the script to be executed. For example, when the task is to run the script named “DeployVM.ps1” then the data 306 may include the identifier (e.g. “-VMID 123”). This allows new task types to be added to the system without requiring any changes to compiled or other binary parts of the system.

Data 306 is used to store data that is associated with the task. For example, the data may be set to the tenant, machine, network, VM, etc. on which the task is to be performed. The data 306 may also store one or more values to which a value in a database is set. The process running the task may look to the job record to see what value the desired number of machines is set to. The script uses the value in the database to perform the operation.

Owner 308 specifies a process/machine that is executing the process. For example, when a cloud manager machine starts execution of a job, the machine updates the owner 308 portion of the record with an ID of the machine.

Step 310 provides an indication of a step of the current script. For example, the script may divide a task into any number of steps. As the process completes a step of the script, step 310 is updated. A process may also look at step 310 to determine what step to execute in the script and to avoid having to re-execute previously completed steps.

Last run 312 provides a time the script was last started. Each time a script is started, the last run time is updated.

Expire time 314 is a time that indicates when the process should be terminated. According to an embodiment, the expire time is a predetermined amount of time (e.g. five minutes, ten minutes . . . ) after the process is started. The expire time may be updated by a requesting process through the web service API.

Next time 316 is a time that indicates when a task should next be executed. For example, a process may be stopped after completion of a step and be instructed to wait until the specified next time 316 to resume processing.

State 318 indicates a current state and Status 320 indicates a status of a job (e.g. Created, Suspended, Resumed, Executing, Deleted).

Duplicate rows in the database can be removed before they are performed if they have the same task type and data values. For example, multiple requests may be made to perform the same task that are stored in multiple rows of the database.

A job can have one or more locks 355 associated with it. If locks are not available then a job will not be scheduled to run until the locks are available. The locks may be configured in many different ways. For example, the locks may be based on a mutex, a semaphore, and the like. Generally, a mutex prevents code from being executed concurrently by more than one thread and a semaphore restricts a number of simultaneous uses of a shared resource up to a maximum number. According to an embodiment, a lock is a character string that represents a resource. The resource may be any type of resource. For example, the lock may be a farm, a machine, a tenant, and the like. Generally, the locks are used to defer execution of one or more tasks. Each job may specify one or more locks that it needs before running. A job may release a lock at any time during its operation. When there is a lock, the job is not scheduled. A job needing more than one lock requests all locks required at once. For example, a job already in possession of a lock may not request additional locks. Such a scheme assists in preventing possible deadlock situations caused by circular lock dependencies amongst multiple jobs.

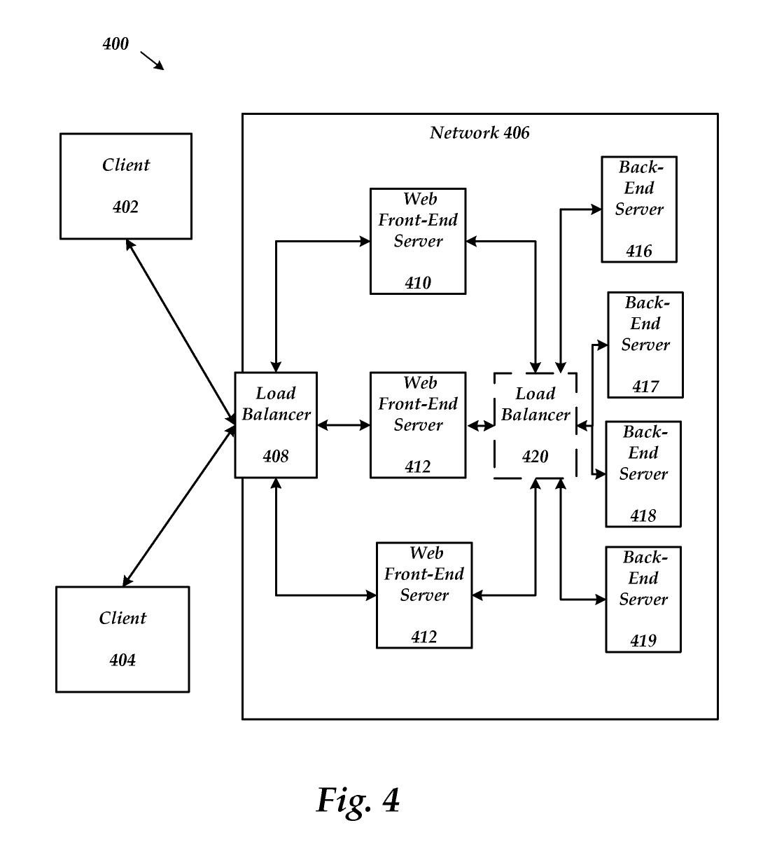

FIG. 4 shows an example system 400 for a network including front-end and back-end servers for an online service. The example system 400 includes clients 402 and 404, network 406, load balancer 408, WFE servers 410, 412, 414 and back-end servers 416-419. Greater or fewer clients, WFEs, back-end servers, load balancers and networks can be used. Additionally, some of the functionality provided by the components in system 400 may be performed by other components. For example, some load balancing may be performed in the WFEs.

In example embodiments, clients 402 and 404 are computing devices, such as desktop computers, laptop computers, terminal computers, personal data assistants, or cellular telephone devices. Clients 402 and 404 can include input/output devices, a central processing unit (“CPU”), a data storage device, and a network device. In the present application, the terms client and client computer are used interchangeably.

WFEs 410, 412 and 414 are accessible to clients 402 and 404 via load balancer 408 through network 406. As discussed, the servers may be configured in farms. Back-end server 416 is accessible to WFEs 410, 412 and 414. Load balancer 408 is a dedicated network device and/or one or more server computers. Load balancer 408, 420, WFEs 410, 412 and 414 and back-end server 416 can include input/output devices, a central processing unit (“CPU”), a data storage device, and a network device. In example embodiments, network 406 is the Internet and clients 402 and 404 can access WFEs 410, 412 and 414 and resources connected to WFEs 410, 412 and 414 remotely.

In an example embodiment, system 400 is an online, browser-based document collaboration system. An example of an online, browser-based document collaboration system is Microsoft Sharepoint® from Microsoft Corporation of Redmond, Wash. In system 400, one or more of the back-end servers 416-419 are SQL servers, for example SQL Server from Microsoft Corporation of Redmond, Wash.

WFEs 410, 412 and 414 provide an interface between clients 402 and 404 and back-end servers 416-419. The load balancers 408, 420 direct requests from clients 402 and 404 to WFEs 410, 412 and 414 and from WFEs to back-end servers 416-419. The load balancer 408 uses factors such as WFE utilization, the number of connections to a WFE and overall WFE performance to determine which WFE server receives a client request. Similarly, the load balancer 420 uses factors such as back-end server utilization, the number of connections to a server and overall performance to determine which back-end server receives a request.

An example of a client request may be to access a document stored on one of the back-end servers, to edit a document stored on a back-end server (e.g. 416-419) or to store a document on back-end server. When load balancer 408 receives a client request over network 406, load balancer 408 determines which one of WFE server 410, 412 and 414 receives the client request. Similarly, load balancer 420 determines which one of the back-end servers 416-419 receive a request from the WFE servers. The back-end servers may be configured to store data for one or more tenants (i.e. customer).

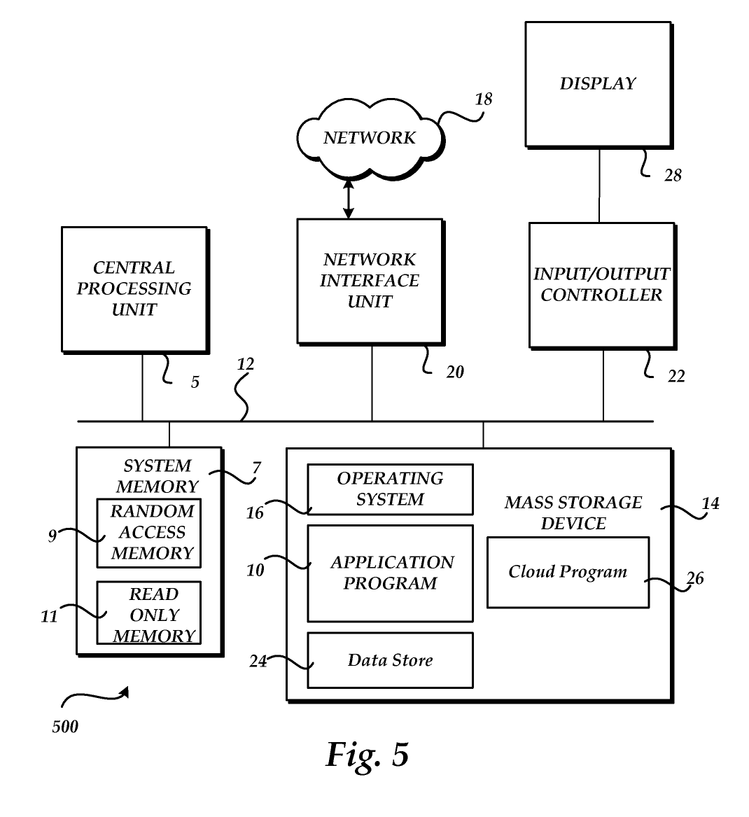

Referring now to FIG. 5, an illustrative computer architecture for a computer 500 utilized in the various embodiments will be described. The computer architecture shown in FIG. 5 may be configured as a server, a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 500 further includes a mass storage device 14 for storing an operating system 16, application programs 10, data store 24, files, and a cloud program 26 relating to execution of and interaction with the cloud system 100.

The mass storage device 14 is connected to the CPU 5 through a mass storage controller (not shown) connected to the bus 12. The mass storage device 14 and its associated computer-readable media provide non-volatile storage for the computer 500. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 500.

According to various embodiments, computer 500 may operate in a networked environment using logical connections to remote computers through a network 18, such as the Internet. The computer 500 may connect to the network 18 through a network interface unit 20 connected to the bus 12. The network connection may be wireless and/or wired. The network interface unit 20 may also be utilized to connect to other types of networks and remote computer systems. The computer 500 may also include an input/output controller 22 for receiving and processing input from a number of other devices, including a keyboard, mouse, or electronic stylus (not shown in FIG. 5). Similarly, an input/output controller 22 may provide output to a display screen 28, a printer, or other type of output device.

As mentioned briefly above, a number of program modules and data files may be stored in the mass storage device 14 and RAM 9 of the computer 500, including an operating system 16 suitable for controlling the operation of a networked computer, such as the WINDOWS® operating systems from MICROSOFT® CORPORATION of Redmond, Wash. The mass storage device 14 and RAM 9 may also store one or more program modules. In particular, the mass storage device 14 and the RAM 9 may store one or more application programs, such as cloud program 26, that perform tasks relating to the cloud system.

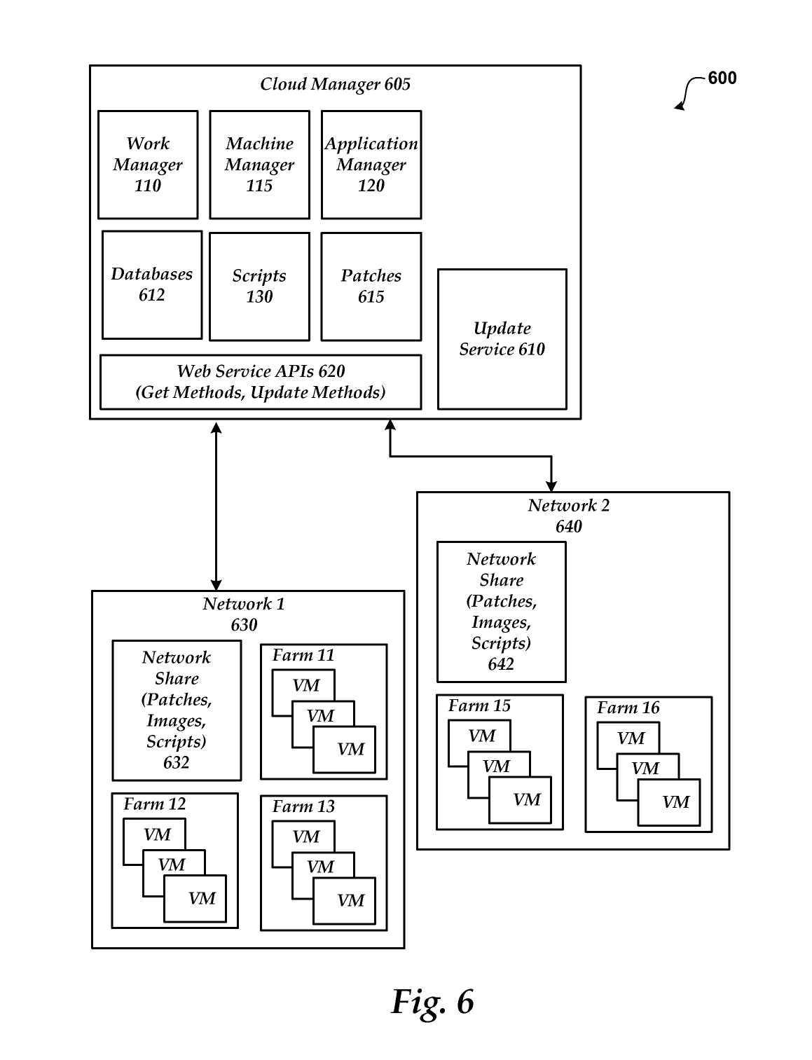

FIG. 6 shows a patch system for patching machines that are used within an online service. Cloud manager 605 is used in deploying, configuring, patching and managing the networks for the online service. The cloud manager is configured to receive requests through an idempotent and asynchronous application web service application programming interface (API) 620 that can not rely on a reliable network.

As illustrated, cloud manager 605 comprises work manager 110, machine manager 115, application specific manager 120, scripts 130, databases 612, patches 615 and web service APIs 620. According to one embodiment, application manager 120 is a SharePoint tenant manager that comprises SharePoint specific logic.

Requests using APIs 620 may be used in the management and the deployment of servers in various topologies across different networks (Network 1, Network 2). While only two networks are shown, many more networks are generally managed (e.g. ten, one hundred, one thousand, ten thousand, and the like). Cloud manager 605 operates and is configured similarly to the cloud manager system shown and described above. The web service APIs 620 includes methods to request services from work manager 110, machine manager 115 and application manager 120. For example, requests may be made using APIs 620 to update a tenant in a database, add a new SQL server, deploy a patch, deploy a new farm, add a new machine, update a VM, obtain values within a data store, and the like.

The Web Service APIs 620 are designed to work in the context of a scalable global service. As network requests are assumed to be inherently unreliable, the APIs assume that any network request might fail and/or hang in transit. Requests using the Web Service APIs 620 are configured to be idempotent. In other words, the same call with the same parameters may be made utilizing the Web Service APIs 620 without changing the outcome.

Cloud manager 605 is designed to do very little processing (<10 ms, <50 ms) before returning a response to any given request. Cloud manager 605 maintains records to keep track of currently requests. For example, cloud manager 605 updates records in a local database, such as databases 612, and if necessary schedules a “job” to perform more lengthy activity later. Once the parameters and job information are committed to the database, the response is sent to the requestor. According to an embodiment, the Web Service APIs 620 are built using SOAP with ASP.net.

Patches 615 are configured to store patches that are to be applied to one or more machines (physical and virtual). Virtual Hard Disk (VHD) images that are in use and/or are to be deployed on one or more of the machines in one or more of the networks may also be stored in the data store that includes the patches and/or in some other location. According to an embodiment, the MICROSOFT VHD file format is used that specifies a virtual machine hard disk that can reside on a native host file system encapsulated within a single file. Patches that are to be applied within a specific network may be moved to a global share and/or to a network share that is local to a network (e.g. network share 632 and network share 642). Storing the patches on a network share saves time in a deployment of the patches since network communication time is reduced.

As discussed, machines in the networks may be upgraded by installing new VHDs and/or by applying a patch to the existing software on the machines. Patches may be provided for different purposes. Some patches may be critical for the operation/security of the machines in the online service whereas other patches may be non-critical and optional to apply. For example, zero-day patches may be used to install a critical software update that is to be installed as soon as possible, whereas other non-critical patches may be reviewed and then the patches that are approved may be automatically applied to the machines.

Software patching can require machines to be rebooted one or more times during the application of the patch(es). For example, one patch may be first installed that requires a reboot of a machine before another patch may be applied to the machine. This reboot/patch cycle may continue until there are no more patches to apply. Cloud manager 605 attempts to orchestrate the patching of the machines within a network of physical and virtual machines that work together to provide an online service such that the overall availability of the service as a whole is maintained.

Each network (e.g. network 1, network 2 (may comprise a large number of machines that are configured with redundancy to perform a number of roles. For example, a first number of machines (e.g. 20) may be configured to provide a first role, a second number of machines may be configured to provide a second role (e.g. 30), a third number of machines may be configured to provide a third role (e.g. 12) and the like. In other words, multiple machines are configured to perform a same role for the online service such that failure of a subset of the machines that is/are performing the role do not cause a complete failure of the performance of that role for the online service.

Patching may be used during many phases of the operation and deployment of the online service. For example, when VHDs are being created, patches may be applied to the VHDs such that they are production-ready at delivery. When physical machines are imaged, they may need to be patched before they are made available to the online service. Existing deployments of machines may need to be patched to ensure their ongoing compliance.

Patches may be delivered at various times to cloud manager 605 and/or to an update service, such as update service 610. For example, non-critical patches may be released at certain times (i.e. every two weeks, every month, and the like) and critical patches may be released as soon as they are available. According to an embodiment, the update service 610 is the Windows Server Update Services (WSUS) from MICROSOFT CORPORATION. The WSUS assists administrators in managing the distribution of patches that are released. While update service 610 is shown internal to cloud manager 605 and network 1 and network 2, update service 610 may be included in one or more of the networks and/or cloud manager 605.

When non-critical patches are received, an authorized user (i.e. system administrator) may review the patches and approve/disapprove them for deployment. An administrator may decide not to deploy certain patches that are non-critical. After the approval process, the patches that are approved may be scheduled to be installed. The patches may be stored at different locations. For example, the patches may be stored in a local network share (e.g. network share 632, network share 642) and/or in a global network share. Initially, the patches may be stored in one location and then provided to another location. For example, the patches may be moved from patches 615 to the network share(s) that is/are associated with the network(s) on which the patches will be deployed.

When critical patches (i.e. zero-day patches) are released, there is very little time available to perform validation on those patches and get them applied to machines within the network. When notification is received of a zero-day patch, the cloud manager 620 and/or update service 610 may schedule the patches to be deployed.

According to an embodiment, machines in each of the networks are joined to a same domain that follows a group policy object (GPO). The GPO governs the behavior of update service 610 on those machines. For example, the GPO may specify that machines within the domain are setup to download new updates when they are available without auto-installing the updates. With the machines following the GPO without auto-install, the application of the patches to the machines may be controlled such that the availability of the online service is maintained during the patching. The scheduling and application of the patches is performed such that downtime of functionality that is provided within the online service is minimized

Critical patches may be automatically configured to deploy at a specific time and/or upon being received. Cloud manager 605 may be configured to trigger installation of the patches after determining an order in which to apply the patches.

Instead of applying the patches to all of the machines that are waiting to be patched at a single time, the patches are applied to groups of machines at different times. The machines waiting to be patched are identified and are partitioned into groups that are highly availability independent groups. A highly available independent group of physical machines is a collection of physical machines such that there are no VMs on any of them that belong to the same farm and also have the same virtual machine role. For example, if you have three machines that are SQL and machine1 is mirrored on machine2, and machine3 is also mirrored on machine2, then machine1 and machine3 can be patched at the same time, but not with machine2. Generally, when there are two or more machines performing a same role for the online service then they are not patched at the same time. In this way, there is at least one machine that is performing the role for the online service.

A schedule to patch each of the groups may be determined using different methods. For example, when a current load is low for the groups waiting to be patched, one or more of the groups may be patched at the same time. When a current load is high for the groups waiting to be patched only a single group may be patched at a time. According to an embodiment, each group is patched sequentially one at a time until all of the groups have been patched. The machines within each of the groups may be patched in parallel. Similarly, when two or more groups are to be patched at the same time, the patching may occur in parallel. The VMs to patch on each machine within a group are also identified. The identification of the VMs to patch is based on a type and role of the VM. The VMs on each of the machines may also be patched in parallel.

Some patches require a first patch to be installed and the machine rebooted before a second patch may be installed. After a patch has been installed on a machine, the update service 610 and/or cloud manager can be used to determine if a reboot is required of the machine. Once the machine is back up and running after a reboot (if necessary), the machine is checked to see if there are any more pending patches to be applied. This process repeats until the machine does not need to have any more patches applied. When there are no pending patches to be applied, the machine is considered patched. If a patch fails, then the machine may be removed from operation or rolled back to a previous state before the patch was attempted to be applied. When a machine is removed, another machine may be configured to take its place.

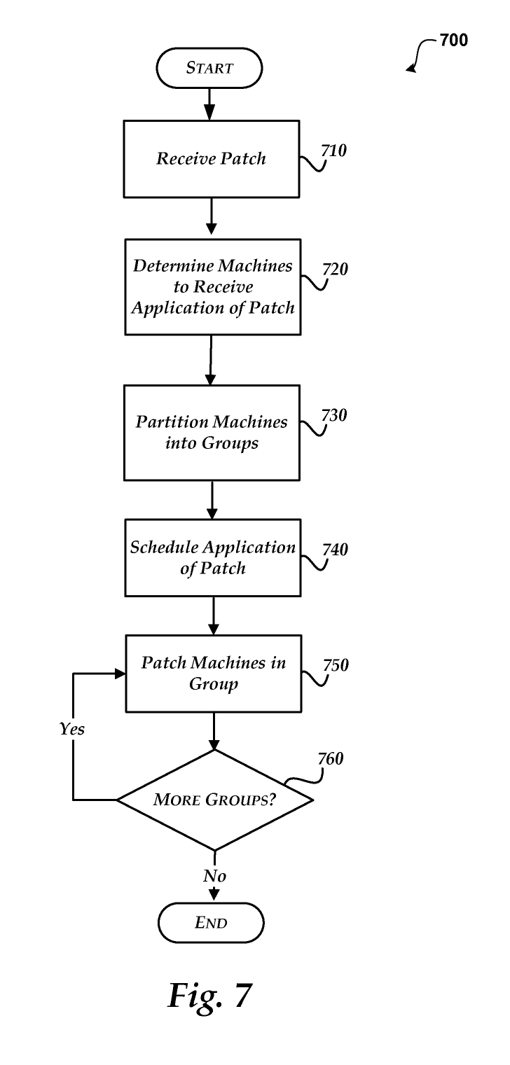

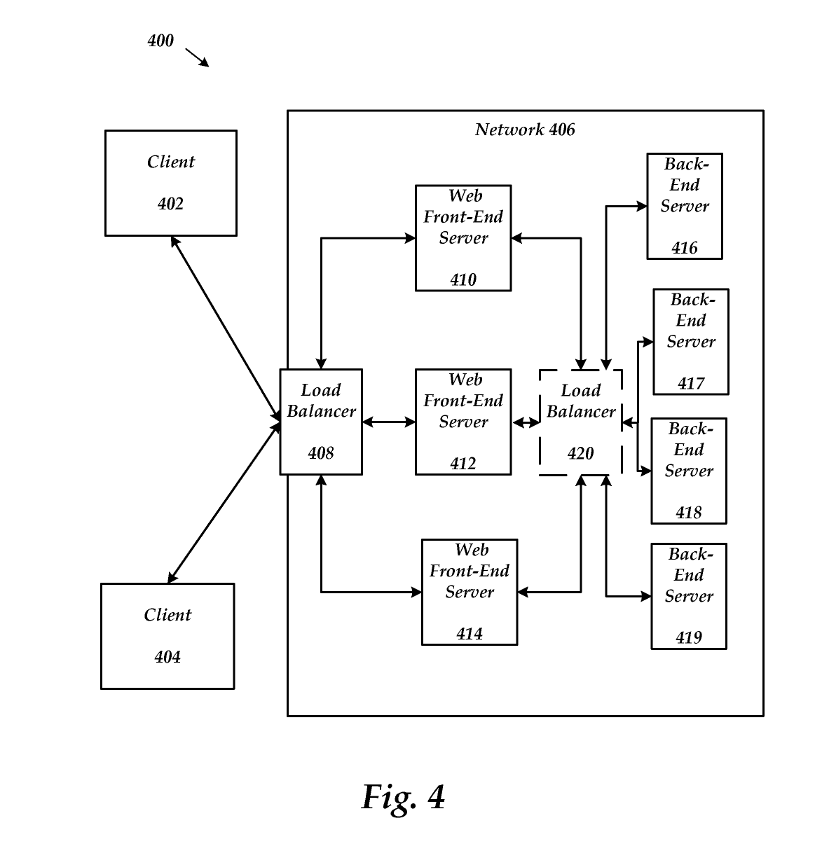

FIG. 7 shows a process for patching machines in an online system.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process 700 flows to operation 710, where a patch is received. As discussed, a patch may be a critical patch or a non-critical patch. Critical patches are to be applied as soon as possible, whereas non-critical patches may be reviewed and scheduled to be applied at a more convenient time.

Moving to operation 720, the machines to receive application of the patch are determined. For example, only a portion of the machines may need to have the patch applied.

Flowing to operation 730, the machines to be patched are partitioned into groups of machines. The partitioning is used to help ensure that application of a patch to machines do not cause a disruption to the overall availability of the online service. According to an embodiment, the machines are partitioned into groups that are highly availability independent groups. A highly available independent group of physical machines is a collection of physical machines such that there are no VMs on any of them that belong to the same farm and also have the same virtual machine role.

Moving to operation 740, the schedule to patch the machines is determined The schedule is used to determine in what order to patch the groups of machines and when to start the patching of the groups of machines. Receipt of a critical patch may trigger the immediate scheduling and application of a patch. Non-critical patches may go through a review process before they are authorized to be applied. Generally, critical patches are to be applied as soon as practicable, whereas non-critical patches may be applied at a more convenient time. According to an embodiment, each group is patched at a different time.

Transitioning to operation 750, the machines within a group of machines are patched. According to an embodiment, each of the machines in a group are patched in parallel at the same time. The machines may also be patched sequentially. When each machine within the group has been patched and rebooted if required, the process moves to decision operation 760.

At decision operation 760, a determination is made as to whether there are more groups to be patched. When there are more groups to patch, the process returns to operation 750. When there are not any more groups to be patched, the process moves to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for patching machines in an online service, comprising:
receiving a patch to apply to machines in an online service that comprises networks; wherein the patch is at least one of a critical patch and a non-critical patch;
determining the machines within at least one of the networks to receive application of the patch; wherein the determined machines comprise a plurality of machines that perform a same role for the online service; and
automatically applying the patch to a portion of the plurality of machines that perform the same role before applying the patch to a remaining portion of the plurality of machines.

2. The method of claim 1, further comprising partitioning the determined machines into groups of machines such that machines that are performing the same role for the online service are partitioned between at least two of the groups.

3. The method of claim 2, wherein automatically applying the patch comprises automatically applying the patch to each of the machines within a group before applying the patch to a next group.

4. The method of claim 3, wherein applying the patch to each of the machines within the group comprises applying the patch to each of the machines within the group in parallel.

5. The method of claim 2, further comprising determining any virtual machines on each of the machines that is to receive application of the patch.

6. The method of claim 5, further comprising applying the patch to each of the virtual machines on each of the machines in parallel.

7. The method of claim 2, wherein the patch is received by an update service that is configured to apply the patch to the machines according to a schedule to patch each of the groups.

8. The method of claim 2, wherein the machines within the network follow a group policy that enforce restrictions on when to apply the patch.

9. The method of claim 3, further comprising checking for an additional patch to apply to the machines within the group and applying the additional patch to the machines in the group before applying the patch to the next group.

10. A computer-readable storage medium having computer-executable instructions for patching machines for an online service, comprising:
receiving a patch to apply to machines in an online service that comprises networks; wherein the patch is at least one of a critical patch and a non-critical patch;
determining the machines within at least one of the networks to receive application of the patch; wherein the determined machines comprise a plurality of machines that perform a same role for the online service;
partitioning the determined machines into groups of machines such that machines that are performing the same role for the online service are partitioned between at least two of the groups;
scheduling when to apply the patch to the groups; and
automatically applying the patch sequentially to each of the groups according to the schedule.

11. The computer-readable storage medium of claim 10, wherein automatically applying the patch comprises automatically applying the patch to each of the machines within each of the groups in parallel.

12. The computer-readable storage medium of claim 10, further comprising determining any virtual machines on each of the machines that is to receive application of the patch.

13. The computer-readable storage medium of claim 12, further comprising applying the patch to each of the virtual machines on each of the machines in parallel.

14. The computer-readable storage medium of claim 10, wherein the patch is received by an update service that is configured to apply the patch to the machines.

15. The computer-readable storage medium of claim 10, wherein the machines are members of a domain within the network that follows a group policy that enforce restrictions on when to apply the patch.

16. The computer-readable storage medium of claim 10, further comprising checking for an additional patch to apply to the machines within the group and applying the additional patch to the machines in the group before applying the patch to the next group.

17. A system for patching machines that provide an online service, comprising:
a processor and a computer-readable medium;
an operating environment stored on the computer-readable medium and executing on the processor;
a cloud manager that is coupled to different networks that is operative to manage deployment of machines and configuration of the networks and that automatically schedules when a patch is to be applied to machines in the online service;
a data store in each of the different networks that is used to store the patch that is to be applied to machines within that network; and
a patch system that is configured to perform actions, comprising:
receive a patch to apply to machines in an online service that comprises networks; wherein the patch is at least one of a critical patch and a non-critical patch;
determine the machines within at least one of the networks to receive application of the patch; wherein the determined machines comprise a plurality of machines that perform a same role for the online service;
partition the determined machines into groups of machines such that machines that are performing the same role for the online service are partitioned between at least two of the groups; and
automatically apply the patch to a portion of the groups before applying the patch to another portion of the groups.

18. The system of claim 17, wherein automatically applying the patch comprises automatically applying the patch to each of the machines within each of the groups in parallel.

19. The system of claim 17, further comprising determining any virtual machines on each of the machines that is to receive application of the patch and applying the patch to each of the virtual machines on each of the machines in parallel.

20. The system of claim 17, further comprising checking for an additional patch to apply to the machines within the group and applying the additional patch to the machines in the group before applying the patch to the next group.
